(19) United States
(12) Patent Application Publication
(10) Pub. No.: US 2026/0073620 A1
(43) Pub. Date: Mar. 12, 2026

(54) SYSTEM AND METHOD FOR IMPROVING NOVEL VIEW SYNTHESIS USING LATENT DIFFUSION MODELS IN 3D GAUSSIAN SPLATTING

(71) Applicant: Samsung Electronics Co., Ltd., Gyeonggi-do (KR)

(72) Inventors: Bohan LI, San Diego, CA (US); Xingyi LI, San Diego, CA (US); Yangwen LIANG, San Diego, CA (US); Shuangquan WANG, San Diego, CA (US); Kee-Bong SONG, San Diego, CA (US)

(21) Appl. No.: 19/326,361

(22) Filed: Sep. 11, 2025

Related U.S. Application Data
(60) Provisional application No. 63/693,375, filed on Sep. 11, 2024.

(51) Int. Cl. G06T 15/08; G06N 3/045; G06T 15/20

(52) U.S. Cl. CPC G06T 15/08; G06N 3/045; G06T 15/20

(57) ABSTRACT

A system and method are disclosed. The method includes rendering an image using a three-dimensional (3D) Gaussian splatting process; processing the rendered image with a pretrained latent diffusion model to estimate noise in a latent space; generating a diffusion loss based on a difference between the estimated noise and a sampled noise; periodically applying the diffusion loss to update parameters of the 3D Gaussian splatting process; and generating a novel view synthesis image based on the updated parameters.

### CROSS-REFERENCE TO RELATED APPLICATION

This application claims the priority benefit under 35 U.S.C. § 119(e) of U.S. Provisional Application No. 63/693,375, filed on Sep. 11, 2024, the entire contents of which are incorporated herein by reference.

### TECHNICAL FIELD

The disclosure generally relates to computer vision and three dimensional (3D) scene reconstruction. More particularly, the subject matter disclosed herein relates to improvements to rendering quality in novel view synthesis by enhancing 3D Gaussian splatting techniques with pretrained latent diffusion models.

### SUMMARY

Photorealistic images of a scene from viewpoints that were not part of the original input, using sparse or multi-view two dimensional (2D) images, may be generated through a process known as novel view synthesis, in which a reconstructed 3D representation is rendered from new or unseen camera poses. This technology is useful in fields such as augmented reality, virtual reality, digital content creation, and autonomous systems. One approach used for novel view synthesis is 3D Gaussian splatting, which models the scene as a collection of 3D Gaussians whose projections onto the image plane are differentiable and can be optimized using gradient-based methods.

Some systems rely solely on photometric reconstruction loss to train 3D Gaussian parameters. While these methods achieve competitive rendering results, they lack access to strong visual priors and may converge to suboptimal representations, particularly in visually ambiguous regions. Other solutions have attempted to incorporate generative models into view synthesis, but these often require expensive modifications to the 3D representation or introduce substantial inference-time overhead.

One issue with the above approach is that optimization based on pixel-space reconstruction may cause 3D Gaussian parameters to settle into local minima that are not globally consistent with the distribution of natural images. In addition, techniques that apply generative models directly at inference time can result in increased latency and hardware requirements, making them unsuitable for real-time or resource-constrained applications.

To overcome these issues, systems and methods are described herein for integrating a pretrained latent diffusion model into the training process of a 3D Gaussian splatting pipeline. The disclosed approach may apply a perceptual loss derived from the denoising objective of a latent diffusion model to intermediate renderings during training. This loss may be computed in a low-dimensional latent space and applied intermittently (e.g., every k iterations) to guide the optimization process. The diffusion model may remain frozen and not used during inference, allowing the rendering system to benefit from learned visual priors without incurring runtime cost. In some embodiments, the latent loss may be combined with standard photometric losses (e.g., Layer 1 (L1) or structural similarity index measure (SSIM)) to jointly supervise the 3D reconstruction process.

The above approaches improve on previous methods because they provide a lightweight and modular mechanism to inject rich semantic information into the training process without modifying the underlying 3D representation or increasing inference complexity. As a result, the disclosed systems produce higher quality novel views with improved edge sharpness, texture consistency, and robustness to sparse input images, while maintaining the real-time rendering benefits of 3D Gaussian splatting.

According to an aspect of the disclosure, a method includes rendering an image using a 3D Gaussian splatting process; processing the rendered image with a pretrained latent diffusion model to estimate noise in a latent space; generating a diffusion loss based on a difference between the estimated noise and a sampled noise; periodically applying the diffusion loss to update parameters of the 3D Gaussian splatting process; and generating a novel view synthesis image based on the updated parameters.

According to another aspect of the disclosure, an apparatus includes a processor and a memory storing instructions that, when executed by the processor, cause the processor to render an image using a 3D Gaussian splatting process; process the rendered image with a pretrained latent diffusion model to estimate noise in a latent space; generate a diffusion loss based on a difference between the estimated noise and a sampled noise; periodically apply the diffusion loss to update parameters of the 3D Gaussian splatting process; and generate a novel view synthesis image based on the updated parameters.

### BRIEF DESCRIPTION OF THE DRAWING

In the following section, the aspects of the subject matter disclosed herein will be described with reference to exemplary embodiments illustrated in the figures, in which:

FIGS. 1A-1B illustrate the process of novel view synthesis from a dense set of training images using the 3D Gaussian splatting (3DGS) framework, according to an embodiment;

FIG. 2A-2B are a schematic overview of a LatentDiff-3DGS architecture to enhance novel view synthesis, according to an embodiment;

FIG. 3 is a flowchart illustrating a method for generating a novel view synthesis image, according to an embodiment;

FIG. 4 is a block diagram of an electronic device in a network, according to an embodiment; and

FIG. 5 is a wireless communication system including a UE and a gNB, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“3D Gaussian splatting process” as used herein refers to a computer-implemented rendering technique that represents a scene using a collection of 3D Gaussian primitives, which are projected onto a 2D image plane to generate an image. The 3D Gaussian splatting process may involve adjusting position, scale, rotation, and other attributes of each Gaussian to achieve an approximate view of a scene.

“Latent diffusion model” as used herein refers to a generative model architecture that operates within a compressed or latent representation space to synthesize or transform data using denoising diffusion processes. The latent diffusion model may be pre-trained on natural images and applied during inference to predict noise residuals from latent inputs.

“Diffusion loss” as used herein refers to a numerical error metric that quantifies the discrepancy between a predicted noise estimate and a sampled noise used during a diffusion-based training process. Some examples of “diffusion loss” include a mean squared error (MSE) loss between predicted and actual noise, or other distance metrics computed in latent space.

“Novel view synthesis image” as used herein refers to an image generated from a viewpoint that differs from those used during the original training or rendering processes. Novel view synthesis images may be generated using updated rendering parameters obtained through training or optimization routines. Some examples of “novel view synthesis image” are red green blue (RGB) frame(s) generated for a new camera position and orientation along a user-defined trajectory, a high-resolution render for a virtual dolly or orbit path, and a sequence of frames forming a fly-through using the same updated parameters.

“Periodically applying the diffusion loss” as used herein refers to the act of using the diffusion loss at defined intervals rather than at every training iteration. Some examples of “periodically applying the diffusion loss” include computing and using the loss every k steps during optimization, alternating between standard reconstruction and diffusion loss objectives, or activating the loss only during specific phases of training.

“Sampled noise” (ε) as used herein refers to a random perturbation tensor in latent space drawn from a predefined distribution and injected at a diffusion timestep to form a noised latent. Some examples of “sampled noise” are a set of values selected to match a latent shape, and a variance-preserving Gaussian generated from a random seed.

“Estimated noise” (ε_{predict}) as used herein refers to a tensor that approximates the additive sampled noise at a chosen timestep, computed by applying a pretrained latent diffusion model to the noised latent. Some examples of “estimated noise” are a direct ε-prediction output and an ε obtained by converting a velocity parameter.

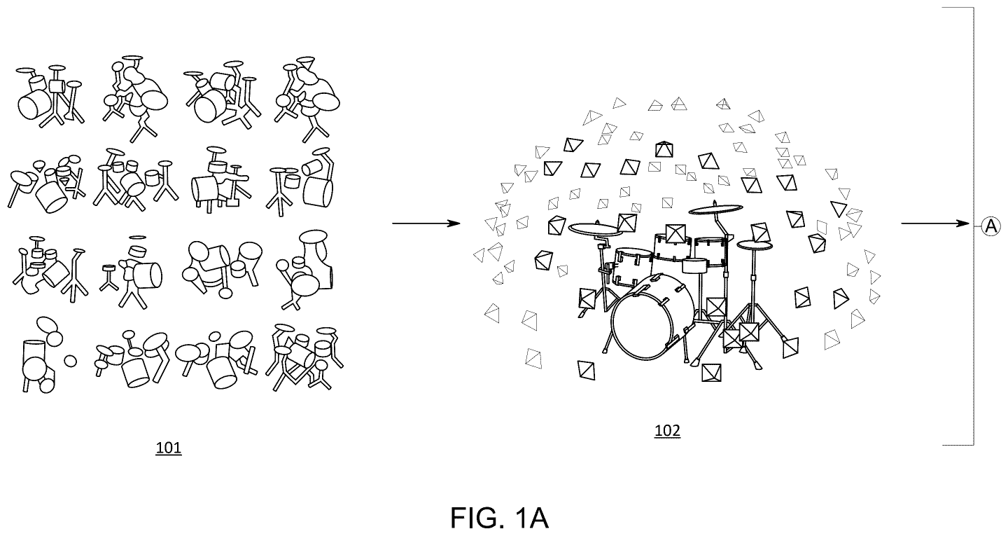

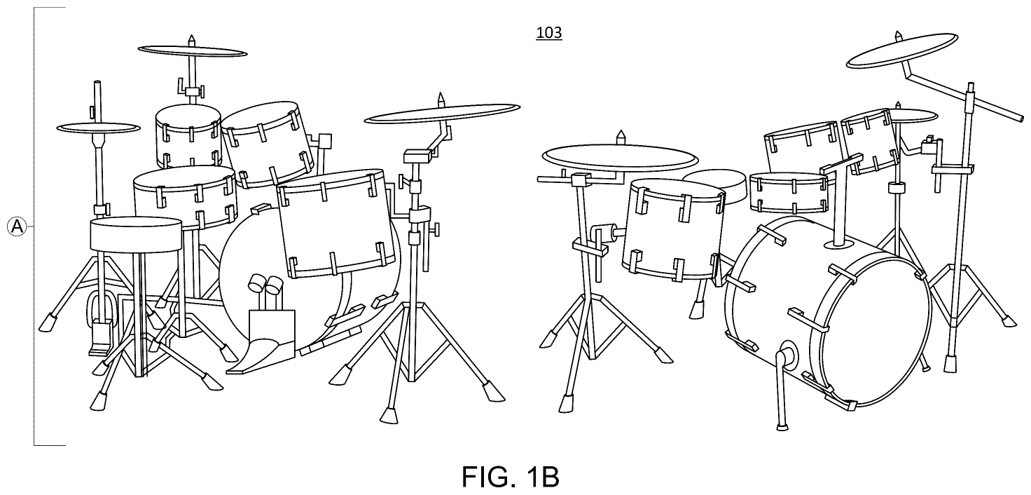

FIGS. 1A-1B illustrate the process of novel view synthesis from a dense set of training images using the 3DGS framework, according to an embodiment.

Referring to FIGS. 1A-1B, a large number of 2D input images are shown at reference numeral 101, each captured from a distinct camera pose surrounding a central object, in this case, a drum set. These multi-view images serve as the source data for reconstructing the 3D scene.

The camera poses are visualized in a spherical distribution around the object at reference numeral 102, highlighting the wide range of viewpoints used during training. This dense camera coverage enables the system to accurately learn the geometry and appearance of the scene from multiple angles. At reference numeral 103, two photorealistic images of the drum set are shown from novel viewpoints that were not part of the original training set. These output views are synthesized by the 3DGS pipeline based on the learned 3D Gaussian representation. Generating realistic synthetic 2D images can be particularly useful in virtual reality, gaming architecture, entertainment, and other applications.

One of the challenges in the domain of novel view synthesis and 3D scene reconstruction is the ability to accurately and efficiently model complex environments that include multiple objects, varying surface textures, and dynamic lighting conditions. Geometry-based approaches, including structure from motion (SfM) and multi-view stereo (MVS), may be limited in their ability to scale across diverse scene types, and may exhibit degraded performance when image coverage is sparse or when the scene contains visual ambiguities or occlusions.

To improve reconstruction quality, data-driven methods such as neural radiance fields (NeRF)-based systems represent a scene as a continuous volumetric field and utilize a neural network to predict radiance and density values at arbitrary spatial locations. While such techniques have demonstrated the ability to generate highly detailed and photorealistic views, they typically incur high computational costs and require significant memory resources, thereby limiting their suitability for real-time or resource-constrained applications.

To address these limitations, 3DGS may be used as an alternative scene representation technique. In 3DGS, a scene is modeled as a set of spatially distributed 3D Gaussian functions, each characterized by attributes such as position, scale, color, and opacity. These Gaussians collectively approximate the underlying geometry and appearance of the scene, and can be projected onto the image plane using a differentiable rasterization process. This approach reduces memory overhead and enables faster training and rendering times compared to volumetric methods, while maintaining high-quality reconstructions that are robust to variations in lighting, texture, and viewpoint.

Various embodiments of the present disclosure describe an enhanced variant of 3DGS that incorporates pretrained latent diffusion models into the training process to improve rendering quality while maintaining low computational cost. In particular, the disclosed system introduces a method for integrating latent diffusion guidance into the 3DGS training framework to improve the fidelity of synthesized novel views, and a training strategy that selectively applies diffusion-based supervision in a computationally efficient manner, thereby preserving high visual quality without significantly increasing training time or resource usage.

3D scene reconstruction has increasingly explored the use of neural representations and learned generative models to improve both efficiency and rendering fidelity. Among these approaches, two classes of techniques may include 3DGS and diffusion-based generative models.

In 3DGS, a scene is represented as a collection of 3D Gaussian functions, each defining a probabilistic region in space. These Gaussians are used to approximate both geometric structure and radiance in a continuous and differentiable manner. Variants of 3DGS have been developed to improve reconstruction quality and scalability. For example, adaptive approaches dynamically adjust the size and density of Gaussians based on scene content, enabling more compact yet expressive representations. Hierarchical extensions organize Gaussians across multiple spatial resolutions, allowing for progressive refinement and efficient rendering. Additionally, hybrid methods have explored combining the geometric efficiency of 3DGS with neural networks to improve parameter estimation and better capture complex scene attributes.

In addition, diffusion models have emerged as a powerful class of generative techniques for image enhancement tasks such as denoising, inpainting, and super-resolution. These models progressively refine noisy or incomplete inputs through iterative denoising steps, guided by learned distributions derived from large-scale image datasets.

Diffusion models may be integrated with 3DGS, such as systems that enhance rendered images using 2D diffusion priors. While such techniques demonstrate potential for improving image quality, they typically operate in full-resolution image space and may introduce significant computational overhead.

In contrast, embodiments described in the present disclosure incorporate latent diffusion models during training and operates in a compressed latent space. This distinction allows for more efficient optimization while still using rich semantic guidance from the diffusion model. Furthermore, the diffusion-based loss may be applied intermittently (e.g., once every 100 training iterations) which reduces computational load while maintaining high visual fidelity in the resulting novel view renderings.

The present disclosure introduces several technical innovations that distinguish the described system from other approaches involving 3DGS and diffusion-based rendering enhancements. Unlike methods that apply diffusion models directly in high-dimensional RGB image space, the disclosed system integrates a pretrained latent diffusion model that operates in a lower-dimensional latent feature space. This design choice significantly reduces memory usage and computational overhead during training, while still allowing the system to apply semantic priors learned from large-scale image datasets. By incorporating this latent guidance into the optimization of 3D Gaussian parameters, the system may refine the quality of rendered views in a manner that is both perceptually meaningful and computationally efficient.

In addition, the system introduces a training mechanism that applies the diffusion-derived loss at periodic intervals (e.g., once every k iterations) rather than at every training step. This intermittent supervision strategy enables the model to benefit from high-level visual guidance without incurring the full computational cost of continuous diffusion loss evaluation. As a result, the system may maintain high visual fidelity in the rendered outputs while achieving substantial reductions in training time and resource requirements.

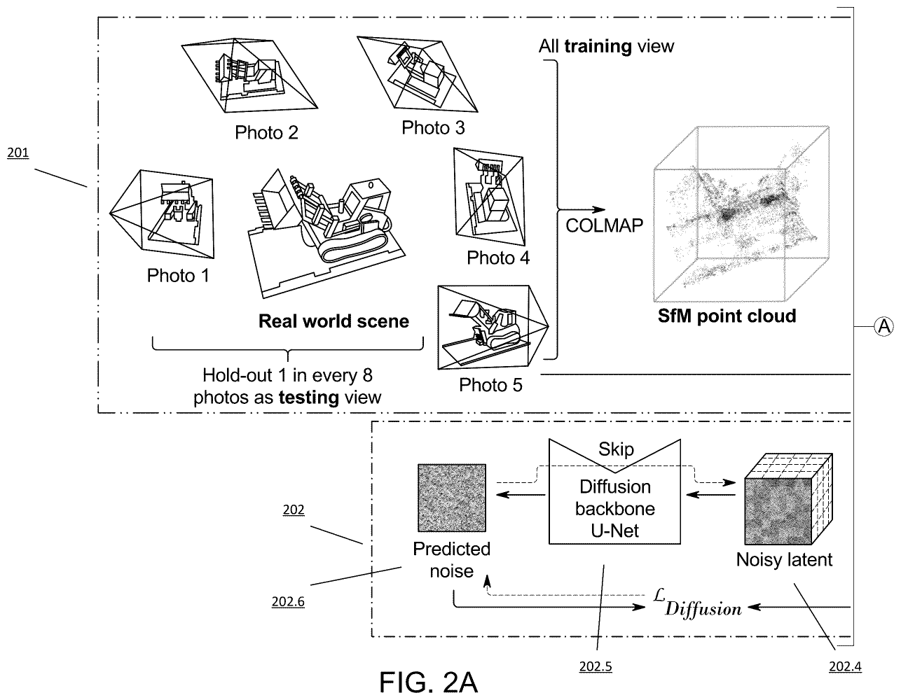

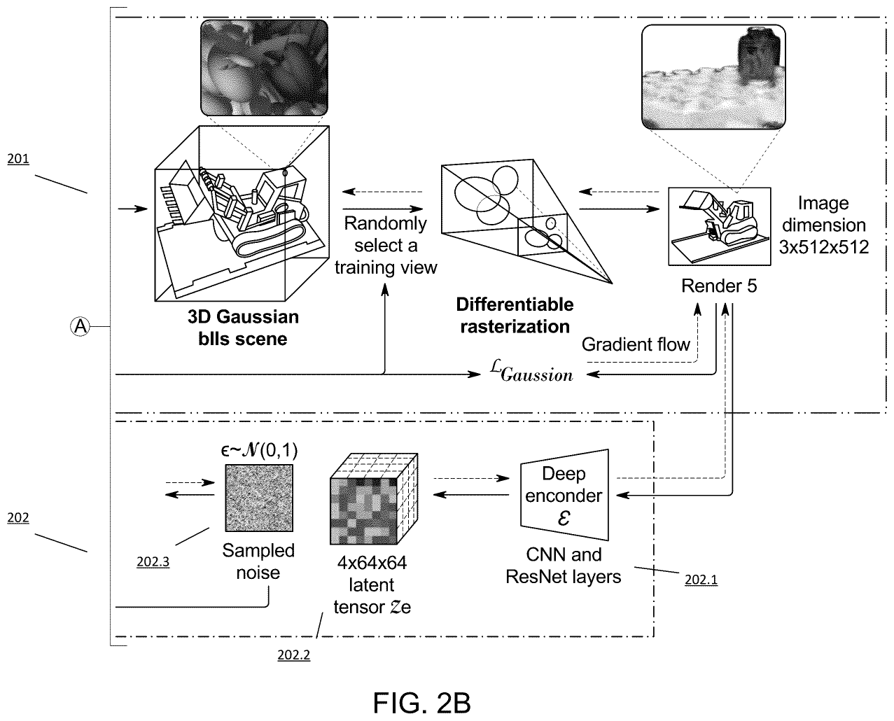

FIG. 2A-2B are a schematic overview of a LatentDiff-3DGS architecture to enhance novel view synthesis, according to an embodiment.

FIGS. 2A-2B illustrate a schematic overview of the LatentDiff-3DGS architecture, which integrates a pretrained latent diffusion model with the 3DGS framework to improve novel view synthesis. The overall system is divided into two sub-frameworks: the components enclosed in box 201 correspond to the standard 3DGS pipeline, while those in box 202 represent the additional latent diffusion module introduced during training.

In the 3DGS portion 201, the system begins by capturing multiple calibrated images of a real-world scene, with a subset of those images designated for testing purposes. Structure-from-motion (SfM) techniques, such as COLMAP, are employed to produce a sparse 3D point cloud based on the training views. This point cloud serves as the basis for initializing a set of 3D Gaussian primitives, which model the scene as a collection of Gaussian distributions in space. Each Gaussian is parameterized by position, scale, opacity, and color attributes. During training, a training image is selected at random, and the corresponding camera parameters are used to project the 3D Gaussians onto a 2D image plane using a differentiable rasterization process. The projection process computes a weighted accumulation of Gaussian contributions at each pixel, based on opacity and projected 2D covariance. This produces a rendered image, which is compared to the ground truth image using a standard reconstruction loss.

The reconstruction loss used in the baseline 3DGS model is a combination of L₁ loss and a differentiable structural similarity index (D-SSIM). Specifically, the baseline loss is given by Equation 1.

$$L = ( 1 - λ ) {L}_{1} + λ \cdot {L}_{D - SSIM} \qquad Equation l$$

where L₁ denotes the pixel-wise absolute difference between the rendered image and the ground truth, and L_{D-SSIM} measures perceptual similarity. In the 3DGS implementation, the weighting factor λ is set to 0.2. Other weighting factors may be used.

The latent diffusion module introduced in the present disclosure is shown in box 202. This sub-framework is based on StableSR, a pretrained latent diffusion model designed for real-world image super-resolution. After the rendered image is generated by the 3DGS renderer, it is passed through a convolutional neural network (CNN) encoder 202.1, which includes ResNet layers, to produce a low-dimensional latent tensor representation 202.2. A noise tensor ε 202.3 sampled from a standard normal distribution is added to this latent representation to simulate a noisy encoding. The resulting noisy latent tensor 202.4 is then input to a frozen U-Net backbone 202.5, which has been pretrained as part of the StableSR latent diffusion model, to predict the noise component 202.6 that was originally added.

To compute the diffusion loss, the same encoder may be used to obtain the latent tensor ze from the corresponding ground truth training image, and a diffusion timestep may be selected (e.g., uniformly or at random). A sampled noise ε may then be drawn in the latent space from a predefined distribution, and the noised latent may be formed. Forward corruption may be used to define the sampled noise ε as a random perturbation added at timestep t.

The diffusion loss may be defined as the squared L₂ norm between the sampled noise ε and the predicted noise ε_{predict} (also referred to “estimated noise”) produced by a pretrained latent diffusion model that receives the noised latent and a representation of the timestep. “Estimated noise” may refer to the model's regression output intended to approximate the additive sampled noise ε used in the forward corruption at timestep t. Both ε and ε_{predict} may be tensors in the latent space. In some embodiments, the parameters of the latent diffusion model are held fixed while gradients of the diffusion loss are back-propagated to update parameters of the 3D Gaussian splatting process. The diffusion loss may be defined according to Equation 2.

$${L}_{Diffusion} ( ε , {ε}_{predict} ) = 𝔼 {‖ ε , {ε}_{predict} ‖}_{2}^{2} \qquad Equation 2$$

The final loss function used for training combines the original reconstruction loss with the additional diffusion-based perceptual supervision. The combined loss may be defined according to Equation 3.

$${L}_{new} = ( 1 - λ ) {L}_{1} + λ \cdot {L}_{D - SSIM} + θ \cdot {L}_{Diffusion} \qquad Equation 3$$

where θ is a tunable parameter that controls the contribution of the diffusion loss. To reduce computational overhead, this full loss is applied periodically, such as once every 100 training iterations, rather than at every training step. This periodic training schedule balances performance and efficiency.

During inference, updated parameters of the 3D Gaussian splatting representation, such as one or more of per-primitive center positions, covariance or scale parameters, color/radiance coefficients (e.g., spherical-harmonic weights), and opacities, may be used to generate a novel view synthesis image from a target camera pose that may differ from any rendered image using the 3D Gaussian splatting representation (corresponding to the image rendered using the 3D Gaussian splatting representation). The splatting renderer may project each 3D Gaussian into the image plane and composite contributions along each view ray via front-to-back alpha blending to produce per-pixel color (and optionally depth) to train a model to generate the novel view synthesis image.

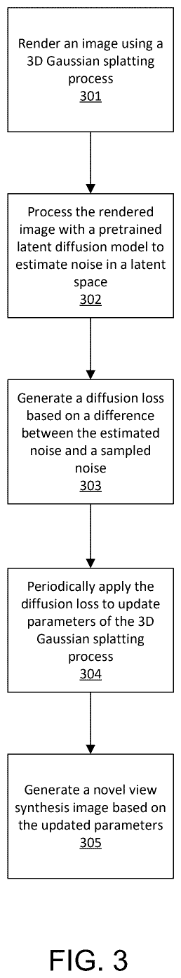

FIG. 3 is a flowchart illustrating a method for generating a novel view synthesis image, according to an embodiment.

In various embodiments, the method may be executed by any electronic device that includes at least one processor operatively coupled to memory and, in some cases, specialized acceleration hardware. Examples include mobile handsets, tablets, laptops, desktops, head-mounted displays, game consoles, servers, and cloud or edge computing nodes.

Referring to FIG. 3, in step 301, an image is rendered using a 3D Gaussian splatting process. A scene representation comprising a plurality of 3D Gaussian primitives (e.g., per-primitive center position, covariance or scale parameters, color/radiance coefficients such as spherical-harmonic weights, and/or opacity) is projected to a selected camera pose, and the splatting renderer composites contributions along view rays (e.g., via front-to-back alpha blending) to produce a rendered image.

In step 302, the rendered image is processed with a pretrained latent diffusion model to estimate noise in a latent space. This may include using an encoder to map the rendered image to a latent tensor; a diffusion timestep may be selected; sampled noise ε may be drawn from a predefined distribution and combined with a latent tensor to form a noised latent; and the pretrained latent diffusion network may process the noised latent to produce the estimated noise.

In step 303, a diffusion loss is generated based on a difference between the estimated noise and the sampled noise. For example, a mean-squared-error loss (optionally with a per-timestep weight) may be computed, with averages taken over timesteps.

In step 304, the diffusion loss is periodically applied to update parameters of the 3D Gaussian splatting process. In one embodiment, gradients of the diffusion loss are back-propagated through the encoder and differentiable renderer into the 3D Gaussian parameters while holding the pretrained diffusion model fixed, and this diffusion-based supervision is applied according to a cadence (for example, once every K training iterations) in combination with reconstruction losses between rendered and ground-truth images on other iterations. The periodic schedule reduces computational overhead while steering the 3D Gaussian parameters toward latents that the diffusion model judges as consistent with natural images.

In step 305, a novel view synthesis image is generated based on the updated parameters. Given target camera intrinsics (camera parameters that describe how a camera maps 3D rays to image pixels independent of its position in the scene) and extrinsics (parameters that describe a camera's pose with respect to a world or scene coordinate frame) that may differ from any training pose, the updated 3D Gaussian representation may be rendered by the splatting process to produce an RGB image (and optionally depth), thereby generating the novel view synthesis image.

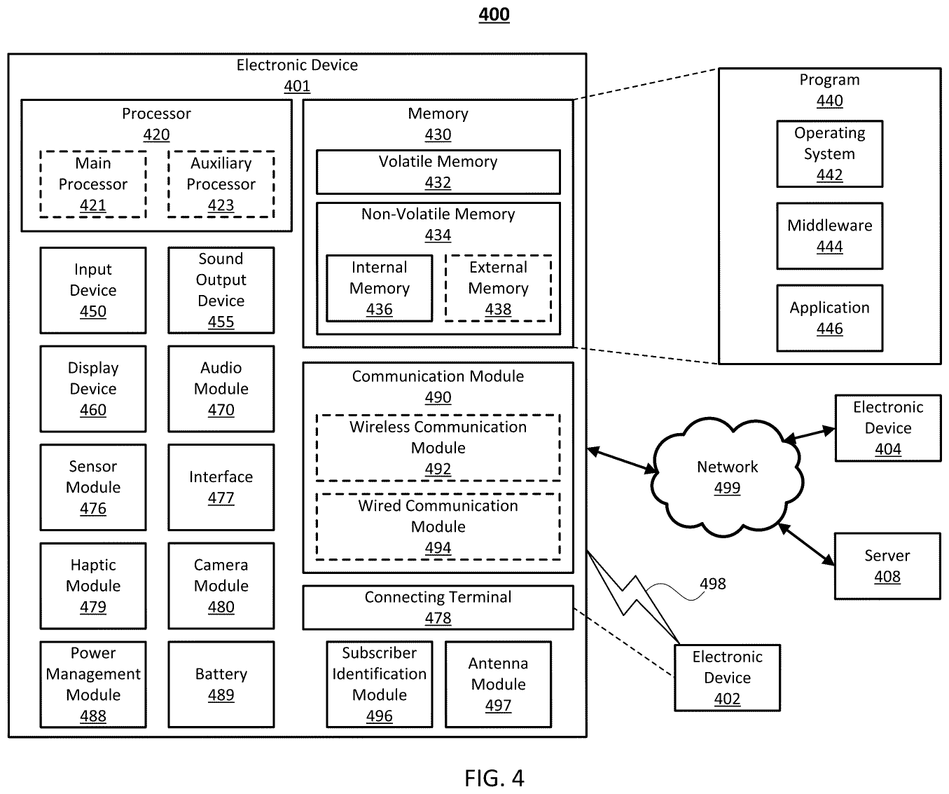

FIG. 4 is a block diagram of an electronic device in a network, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

Embodiments disclosed herein utilize the structural components of FIG. 4 to implement the training and temporal regularization mechanisms described in this application. For example, a camera module 480 may capture a stream of video frames, which are then processed by the processor 420 to apply synthetic jitter, generate a jittered version of the input frame, and perform temporal regularization through the enforcement of a consistency loss. By using this training approach, temporal consistency is improved, reducing flicker and ensuring stable segmentation outputs across video frames.

The memory 430 may store the trained neural network parameters, loss functions, and intermediate feature representations required for segmenting video frames with temporal consistency. Additionally, memory 430 may retain historical segmentation data or previous feature maps, allowing the processor 420 to compare current and prior predictions, reinforce stability in overlapping pixel regions, and refine segmentation results. This local storage strategy enables the electronic device 401 to operate efficiently in real-time or near real-time without requiring cloud-based processing.

The communication module 490 may enable connectivity with external servers 408 or other devices 402 or 404, allowing updates to the segmentation model, refinement of training parameters, synchronization of segmented video outputs, or the exchange of additional data to support adaptive learning and improve model robustness over time.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

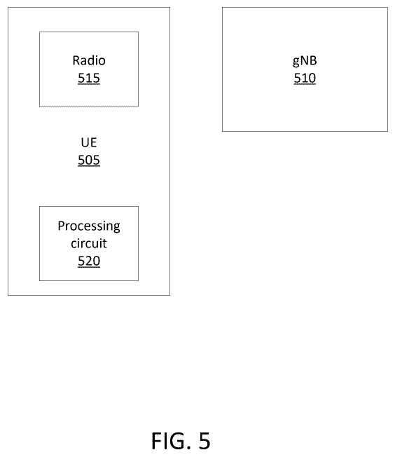

FIG. 5 is a wireless communication system including a UE and a gNB, according to an embodiment.

Referring to FIG. 5, a system including a UE 505 and a gNB 510, in communication with each other, is illustrated. The UE 505 may include a radio 515 and a processing circuit (or a means for processing) 520, which may perform various methods disclosed herein, e.g., the method illustrated in FIG. 3. For example, the processing circuit 520 may receive, via the radio 515, transmissions from the network node (gNB) 510, and the processing circuit 520 may transmit, via the radio 515, signals to the gNB 510.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
rendering an image using a three-dimensional (3D) Gaussian splatting process;
processing the rendered image with a pretrained latent diffusion model to estimate noise in a latent space;
generating a diffusion loss based on a difference between the estimated noise and a sampled noise;
periodically applying the diffusion loss to update parameters of the 3D Gaussian splatting process; and
generating a novel view synthesis image based on the updated parameters.

2. The method of claim 1, wherein the diffusion loss comprises a mean squared error between the estimated noise and the sampled noise.

3. The method of claim 1, wherein the latent diffusion model comprises an encoder configured to transform the rendered image into a latent representation, and a frozen U-Net configured to denoise the latent representation.

4. The method of claim 1, further comprising computing the diffusion loss based on a predetermined number of training iterations.

5. The method of claim 1, wherein the latent diffusion model is configured to operate in an inference mode using parameters obtained from prior training on a dataset of natural images.

6. The method of claim 1, wherein the diffusion loss is combined with one or more image-space reconstruction losses to form a total loss used to update the 3D Gaussian splatting model.

7. The method of claim 1, wherein the updating of the parameters of the 3D Gaussian splatting model comprises adjusting opacity and covariance attributes of a set of 3D Gaussians.

8. The method of claim 1, wherein the 3D Gaussian splatting process comprises projecting 3D Gaussians onto a two-dimensional (2D) image plane and accumulating contributions based on opacity and projected covariance.

9. The method of claim 1, wherein the estimated noise is predicted by the latent diffusion model based on a noisy latent image and a noise level input.

10. The method of claim 1, wherein the rendered image and the novel view synthesis image correspond to different camera viewpoints.

11. An apparatus comprising a processor and a memory storing instructions that, when executed by the processor, cause the processor to:
render an image using a three-dimensional (3D) Gaussian splatting process;
process the rendered image with a pretrained latent diffusion model to estimate noise in a latent space;
generate a diffusion loss based on a difference between the estimated noise and a sampled noise;
periodically apply the diffusion loss to update parameters of the 3D Gaussian splatting process; and
generate a novel view synthesis image based on the updated parameters.

12. The apparatus of claim 11, wherein the instructions further cause the processor to compute the diffusion loss as a mean squared error between the estimated noise and the sampled noise.

13. The apparatus of claim 11, wherein the latent diffusion model comprises an encoder configured to transform the rendered image into a latent representation, and a frozen U-Net configured to denoise the latent representation.

14. The apparatus of claim 11, wherein the instructions further cause the processor to compute the diffusion loss based on a predetermined number of training iterations.

15. The apparatus of claim 11, wherein the latent diffusion model is configured to operate in an inference mode using parameters obtained from prior training on a dataset of natural images.

16. The apparatus of claim 11, wherein the instructions further cause the processor to combine the diffusion loss with one or more image-space reconstruction losses to form a total loss used to update the 3D Gaussian splatting process.

17. The apparatus of claim 11, wherein the instructions further cause the processor to update the parameters of the 3D Gaussian splatting process by adjusting opacity and covariance attributes of a set of 3D Gaussians.

18. The apparatus of claim 11, wherein the instructions further cause the processor to project 3D Gaussians onto a two-dimensional (2D) image plane and accumulate contributions based on opacity and projected covariance.

19. The apparatus of claim 11, wherein the instructions further cause the processor to predict the estimated noise based on a noisy latent image and a noise level input.

20. The apparatus of claim 11, wherein the rendered image and the novel view synthesis image correspond to different camera viewpoints.
